(19) United States
(12) Patent Application Publication
(10) Pub. No.: US 2012/0140149 A1
(43) Pub. Date: Jun. 7, 2012

(54) LIQUID CRYSTAL DISPLAY APPARATUS

(76) Inventors: Koichi SAKITA, Chigasaki (JP); Satoshi Ouchi, Kamakura (JP); Hajime Inoue, Obihiro (JP); Mayumi Nagayoshi, Choufu (JP); Hidenao Kubota, Yokohama (JP); Yoshiharu Yamashita, Hitachinaka (JP); Nobuyuki Kaku, Oiso (JP)

(21) Appl. No.: 13/299,389

(22) Filed: Nov. 18, 2011

(30) Foreign Application Priority Data
Dec. 3, 2010 (JP) 2010-270152

(51) Int. Cl. G02F 1/1335

(52) U.S. Cl. 349/67

(57) ABSTRACT

A liquid crystal display apparatus equipped with a backlight unit includes an LED, a light guide plate for light emission by guiding light from the LED to a liquid crystal panel, an LED board for driving the LED, a reflection sheet interposed between the light guide plate and the LED board, and a chassis on which the LED, the light guide plate, the reflection sheet and the LED board are mounted. The light guide plate has a half length and a half width of the liquid crystal panel, and the reflection sheet has substantially the same size as the light guide plate. The reflection sheet is extended at portions abutting on sides of the chassis to define flanges.

### CLAIM OF PRIORITY

The present application claims priority from Japanese Patent Application JP 2010-270152 filed on Dec. 3, 2010, the content of which is hereby incorporated by reference into this application.

### BACKGROUND OF THE INVENTION

1. Field of the Invention

The present invention relates to a liquid crystal display apparatus equipped with an LED backlight unit as illumination thereof.

2. Related Arts of the Invention

Conventionally, the backlight unit providing a light source for illumination of the liquid crystal display has employed a fluorescent lamp such as CCFL (Cold Cathode Fluorescent Lamp) or EEFL (External Electrode Fluorescent Lamp).

More recently, however, more and more liquid crystal display apparatuses employ LEDs (Light Emitting Diode) as the light source of the backlight unit thereof so that the LEDs are spreading into the mainstream of the light source. In comparison to the conventional fluorescent lamps, the LEDs have the quality to last long and a simple structure to facilitate mass production and thence, are inexpensive. Further, the LEDs are characterized by low power consumption and excellent color reproducibility.

The backlight unit generally includes a direct-lit type which has the light source disposed under a liquid crystal panel and an edge-lit type which has the light source disposed on the side edges of the liquid crystal panel. Patent Literature 1 (JP-A No. 2010-177076) discloses an edge-lit backlight unit wherein LED light enters through side edges of a light guide plate, which guides the light to the liquid crystal panel. The light guide plate is made of a transparent resin or employs, for example, an acrylic plate, which is subjected to special processing for uniform plane emission of light entering through the side edges of the light guide plate.

A structure of the conventional backlight unit is shown in FIG. 11A and FIG. 11B, and described as below. FIG. 11A and FIG. 11B show a part of the conventional backlight unit wherein an LED is assembled with the light guide plate.

Referring to FIG. 11 A and FIG. 11B, a light guide plate is indicated at 50 and an LED substrate is indicated at 30. The light guide plate 50 has a transversely elongate rectangular shape and is made of a transparent material such as an acrylic resin. The light guide plate includes rectangular cavities 51 of an inverted U-shape such as to receive and set the LEDs therein. The cavities are interconnected at upper sides thereof. The cavities are arranged in transverse arrays at a lower side and the center of the light guide plate.

The light guide plate is increased in thickness at the side provided with the array of rectangular cavities, namely the LEDs. The light guide plate is progressively decreased in thickness with distance from the LEDs. The LEDs are inserted and set in the rectangular cavities of the light guide plate 50. The LEDs emit light toward end faces of the rectangular cavities. The light entering through the side edges of the light guide plate is totally reflected to propagate through the light guide plate so as to be emitted from an entire top surface of the light guide plate.

The light guide plate 50 has a reflection sheet 40 on the back side thereof for increasing the luminous efficiency thereof.

Two LED arrays are mounted on the LED substrate. It has been a conventional practice to assemble the light guide plate with the LED substrate, as shown in FIG. 11B, followed by inserting the reflection sheet 40 between the light guide plate 50 and the LED substrate 30. Such a manufacture method has a drawback of low work efficiency of inserting the reflection sheet 40 between the light guide plate 50 and the LED substrate 30. Furthermore, the wide LED substrate is required, resulting in the wasteful use of material and the weight increase. In addition, the backlight unit suffers poor reflection efficiency because the reflection sheet is designed to have the same size as that of the light guide plate.

There may be a case where the light guide plate 50 having a smaller area (area of light emission surface) than that of an effective display region of the liquid crystal panel is used. In this case, the liquid crystal panel is decreased in the quantity of light supplied to edges of the effective display region so that an image is decreased in luminance at an area in the vicinity of the edges of the liquid crystal panel.

### SUMMARY OF THE INVENTION

In view of the above, the invention seeks to provide a liquid crystal display apparatus including a backlight unit that features high work efficiency and productivity and achieves weight reduction and increase in LED light reflection efficiency. Further, the invention aims to address the case of use of the light guide plate smaller than the effective display region of the liquid crystal panel, providing a technique suitable for preventing the image from being decreased in luminance at the area in the vicinity of the edges of the liquid crystal panel.

The above objects of the invention are accomplished in a liquid crystal display apparatus equipped with a backlight unit comprising: an LED; a light guide plate for light emission by guiding light from the LED to a liquid crystal panel; an LED board for driving the LED; a reflection sheet interposed between the light guide plate and the LED board; and a chassis on which the LED, the light guide plate, the reflection sheet and the LED board are mounted, the light guide plate having an emission surface opposed to the liquid crystal panel and divided into a plurality of sections, the backlight unit controlling the intensity of light through each of the sections according to an image, the liquid crystal display apparatus wherein the light guide plate has a half length and a half width of the liquid crystal panel, and wherein the reflection sheet has substantially the same size as the light guide plate and is extended at portions abutting on sides of the chassis.

The invention provides a structure wherein the light guide plate used in the backlight unit has a half length and a half width of the liquid crystal panel or is one fourth the size of the liquid crystal panel, wherein the LED substrates carrying the LEDs are arranged in three rows relative to the light guide plate and wherein a plurality of LEDs are arranged in each row of LED substrate. The structure allows for the size reduction of the substrate. Further, the two-by-two configuration of the light guide plate produces improvement in work efficiency and productivity. What is more, the reflection sheet is larger than the light guide plate as extended at portions abutting on the chassis, thereby achieving increased reflection efficiency.

### BRIEF DESCRIPTION OF THE DRAWINGS

FIG. 1 is an exploded perspective view showing a structure of a backlight unit according to the invention;

FIG. 2 is a sectional view showing the backlight unit of FIG. 1 assembled in position;

FIG. 3A is a front view showing a round rod of a mold pin for fixing together alight guide plate, a reflection sheet and an LED substrate shown in FIG. 2;

FIG. 3B is a front view showing a casing for receiving the round rod of the mold pin shown in FIG. 3A;

FIG. 3C is a front view showing the mold pin having the round rod of FIG. 3A assembled in the casing of FIG. 3B;

FIG. 3D is a bottom view showing the mold pin of FIG. 3C;

FIG. 4A is a top plan view showing the LED substrate of the invention;

FIG. 4B is an enlarged fragmentary top plan view showing the LED substrate of FIG. 4A;

FIG. 4C is an enlarged fragmentary perspective view showing the LED substrate of FIG. 4A;

FIG. 5A is top plan view showing the light guide plate of the invention;

FIG. 5B is a sectional view of the light guide plate taken on the line B-B′ in FIG. 5A;

FIG. 5C is an enlarged fragmentary perspective view showing the light guide plate of FIG. 5A;

FIG. 5D is a sectional view of the light guide plate taken on the line C-C′ in the enlarged fragmentary perspective view of FIG. 5C;

FIG. 5E is a diagram showing a surface pattern of the light guide plate of FIG. 5A;

FIG. 6 is a top plan view showing the reflection sheet of the invention;

FIG. 7 is a fragmentary perspective view showing the reflection sheet of the invention;

FIG. 8 is a fragmentary sectional view showing a relation between the reflection sheet and a chassis of the invention;

FIG. 9A is a top plan view showing the chassis accommodating the backlight unit;

FIG. 9B is a sectional view of the chassis taken on the line A-A′ in FIG. 9A;

FIG. 10 is a perspective view showing a back side of the chassis on which various functional boards of a liquid crystal display apparatus are mounted; and

FIG. 11A is a top plan view showing conventional light guide plate and LED substrate assembled together; and

FIG. 11B is sectional view taken on the line D-D′ in FIG. 11A.

### DETAILED DESCRIPTION OF THE PREFERRED EMBODIMENT

A preferred embodiment of the invention will hereinbelow be described in detail with reference to the accompanying drawings.

### First Embodiment

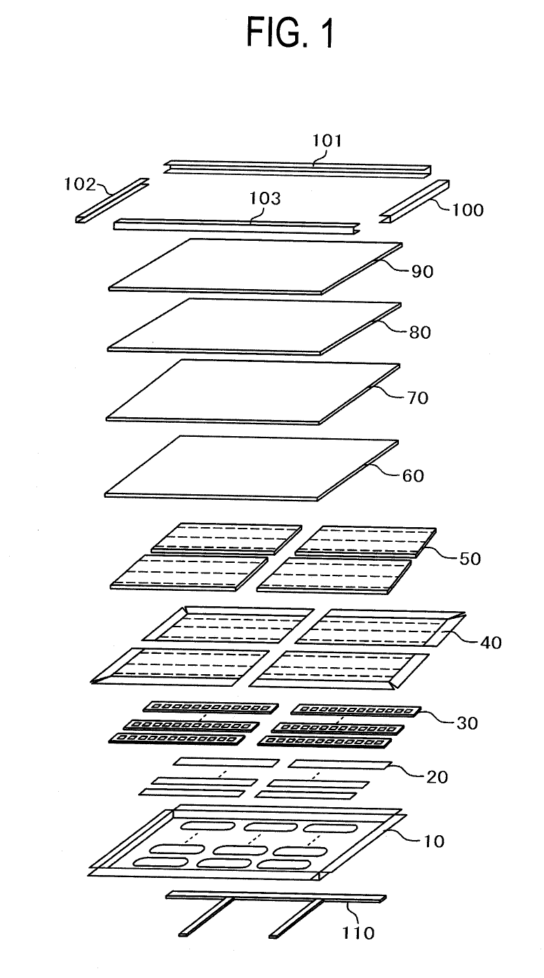

FIG. 1 is an exploded perspective view showing a structure of a backlight unit of a liquid crystal display apparatus.

Referring to FIG. 1, the backlight unit includes a chassis 10, an insulation sheet 20 for insulation between the chassis and an LED substrate, the LED substrate 30 with LEDs mounted thereon, a reflection sheet 40 for reflecting LED light, a light guide plate 50 for plane emission of the LED light, a diffuser plate 60, a diffuser sheet 70, a prism sheet 80 and a reflective polarization sheet 90. These components are collectively fixed in mold frames 100,101,102,103. The backlight unit is a device to irradiate a liquid crystal panel with light. The liquid crystal panel defines a display screen and has a structure wherein a liquid crystal material is sandwiched between two transparent substrates on respective inner sides of polarization filters having a thickness on the order of 0.2 mm and is sealed with a sealing material applied all around the resultant assembly so as to prevent leakage. Of the two substrates, a color filter substrate is disposed on a front side of the liquid crystal panel while an array substrate is disposed on a back side thereof.

In addition to the structure shown in FIG. 1, the invention further provides an operation to analyze luminance signal of an image and to control light emitted per block to a proper luminance. The operation precisely controls the light emitted from the backlight for fine representation of light-dark contrast of the image. A dark area of the image is reduced in intensity of light from the backlight whereas a bright area of the image is increased in intensity of light from the backlight. Thus is produced a crisp image with high light-dark contrast. According to the invention, the lightness is controlled on the basis of one block consisting of three LEDs.

The diffuser plate 60 is adapted for efficient and uniform transmission of light from the light guide plate to the liquid crystal panel. Examples of a usable material principally include MS resins (styrene-methylmethacrylate copolymer resins), PS resins, PC resins and the like. The diffuser plate 60 is made of a base resin, such as MS or PS, to which a light diffusing agent such as acrylic or silicone is admixed for enhancing light diffusing performance.

The diffuser sheet 70 is a translucent sheet capable of light scattering and diffusion for uniform transmission of LED light to the entire surface of the liquid crystal panel.

The diffuser sheet serves not only for uniformly transmitting the light but also for making dots of the light guide plate less visible. Examples of a usable material of the diffuser sheet include PET and the like.

The prism sheet 80 is a kind of lens sheet and used for increasing the luminance of light emitted to the liquid crystal panel in a front direction thereof. The prism sheet includes a base film (polyester resin) and a prism layer (acrylic resin or photopolymer).

Next, a procedure of assembling the backlight unit is described.

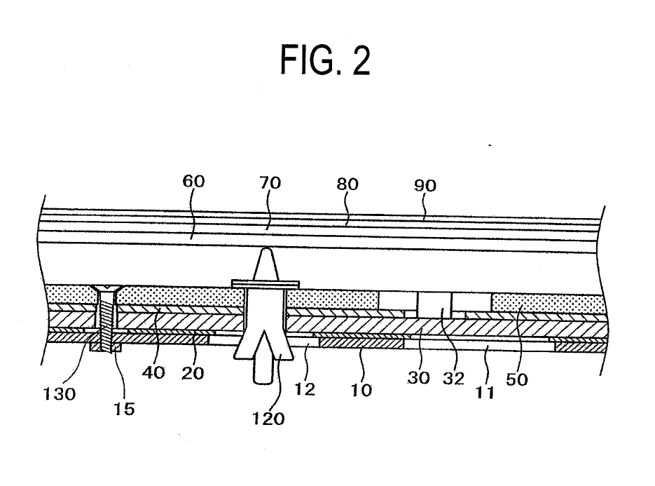

FIG. 2 is a sectional view showing the components of FIG. 1 assembled together.

Referring to FIG. 2, the chassis 10, the insulation sheet 20, the LED substrate 30, the reflection sheet 40, the light guide plate 50 with space defined thereabove, the diffuser plate 60, the diffuser sheet 70, the prism sheet 80 and the reflective polarization sheet 90 are laid on top of each other in this order from bottom.

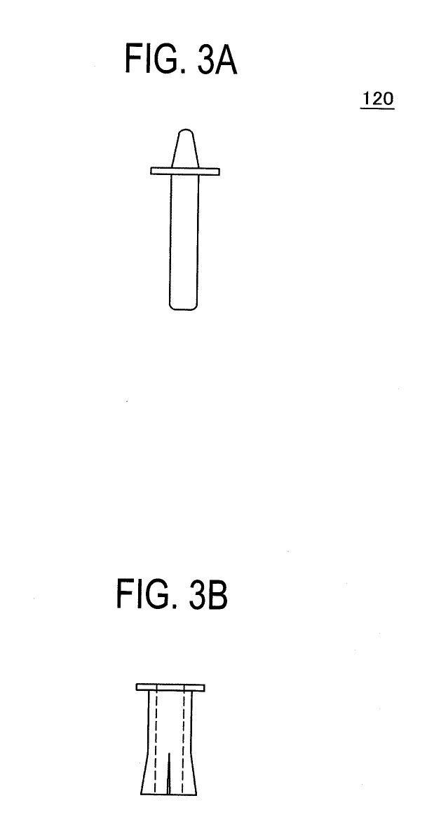

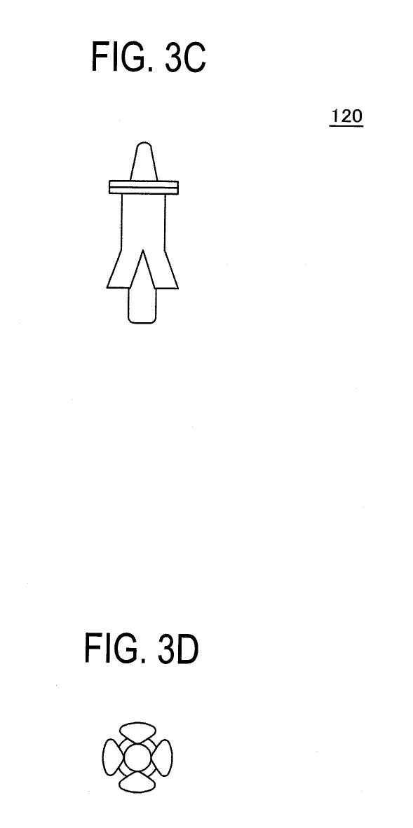

The light guide plate 50, reflection sheet 40 and LED substrate 30 are fixed together by means of a mold pin 120. The mold pin 120 is configured as shown in FIG. 3A to FIG. 3D, and is made of nylon. Specifically, the mold pin includes a flanged round rod as shown in FIG. 3A and a cylindrical casing formed with a flange at one end and slits on the opposite side from the flange as shown in FIG. 3B. The mold pin is configured such that the slits are expanded by inserting the round rod into the casing, as shown in FIG. 3C and FIG. 3D.

Referring to FIG. 2, the mold pin 120 fixes together the light guide plate 50, reflection sheet 40 and LED substrate 30, which are fixed in close contact with each other. While fixing points will be described hereinlater, one LED substrate is fixed at three points according to the invention, but not limited to this.

The light guide plate 30 is fixed to the chassis 10 by means of a screw 130 as shown in a left side portion of FIG. 2. The chassis 10 is formed with a screw socket 15 such that the insulation sheet 20, LED substrate 30 and reflection sheet 40 are also fixed to the chassis by fixing the light guide plate 50. Although FIG. 2 illustrates the light guide plate 50, insulation sheet 20, LED substrate 30 and reflection sheet 40 fixed with the screw 130, it is also possible to use the mold pin 120 for fixing these components.

The mold pin 120 has a specified length of a portion upward from the flange such that a distance between the light guide plate and optical sheets resting on the mold pin is maintained with high precision, the optical sheets including the diffuser plate 60 and the like.

Although FIG. 2 depicts the screw and the mold pin 120 in juxtaposed relation for easy illustration, these components are actually spaced apart.

The chassis 10 is formed with a square opening 11 and a round opening 12 for the mold pin 120. The square opening 11 is formed in correspondence to a back side of the LED substrate to allow connection of wire for driving LEDs.

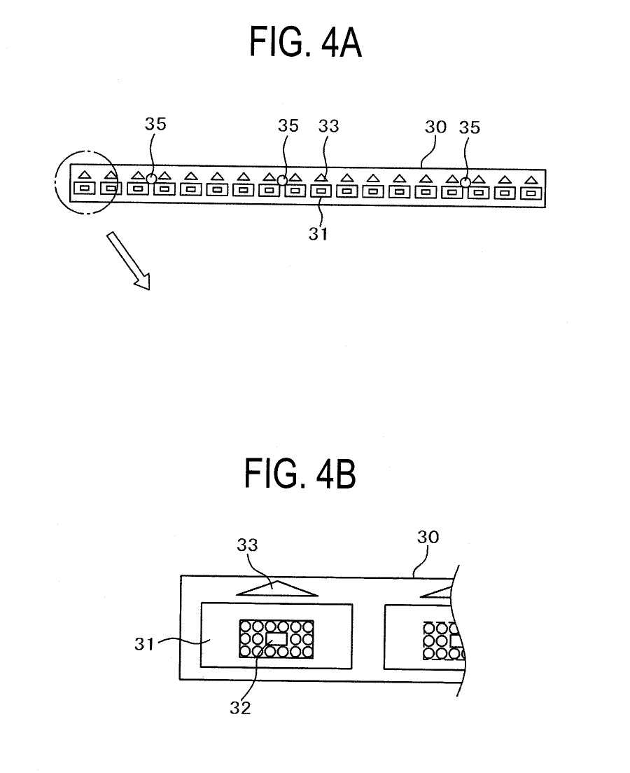

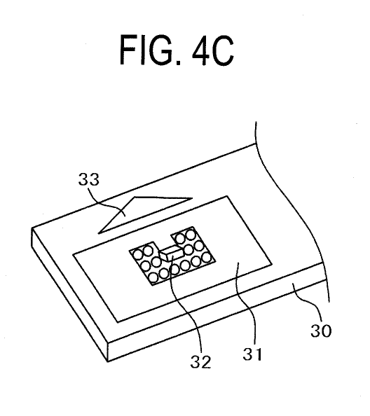

Next, the LED substrate of the invention is described with reference to FIG. 4A to FIG. 4C.

The LED substrate 30 carries thereon LEDs 32 in one array unlike a conventional LED substrate carrying two arrays of LEDs.

In FIG. 4A to FIG. 4C, a rectangular area 31 around the LED 32 is painted white. The reason for painting the area around the LED 32 in the white color is to reflect the light emitted from the LED 32. A triangle mark 33 is painted white on the LED substrate, indicating that the LED emits light in an apical direction of the triangle. The triangle mark is provided for preventing manufacturing workers from mistakenly mounting the LEDs in wrong way.

Circles around the LED 32 represent electrodes and through-holes wired to the back side of the LED substrate. A wiring portion on the back side of the LED substrate corresponds to the square opening 11 in the chassis 10. That is, the LED substrate is driven by control from the back side of the chassis.

The LED 32 is of a side view type that emits light horizontally.

The LED substrate 30 is formed with holes 35 at three points, which are penetrated by the mold pins 120. The LED substrate is further provided with a boss (not shown) for alignment with the light guide plate 50. The alignment between the LEDs and the light guide plate is crucial for the backlight unit and hence, the invention provides the aligning boss on the LED substrate.

Misalignment between the LED substrate and the light guide plate involves a fear that the luminous efficiency of the LEDs is lowered to cause irregular emission of light from the top surface of the light guide plate. This may also lead to a fear of disabling precise control of light emission from the backlight, the precise control accomplished by analyzing the luminance signal of the image and controlling the light emitted per block to a proper luminance.

Next, description is made on the light guide plate of the invention.

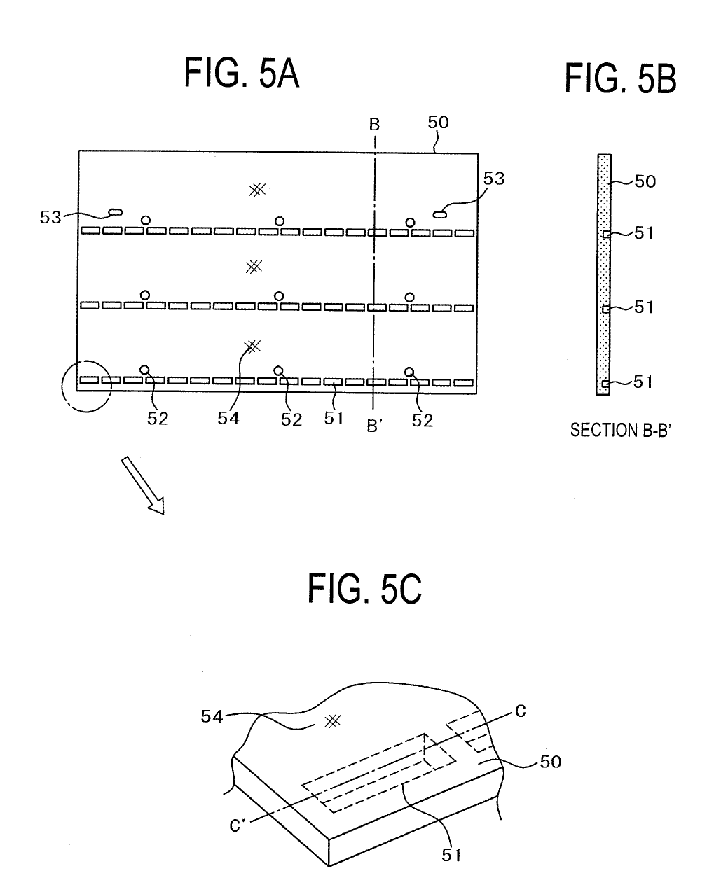

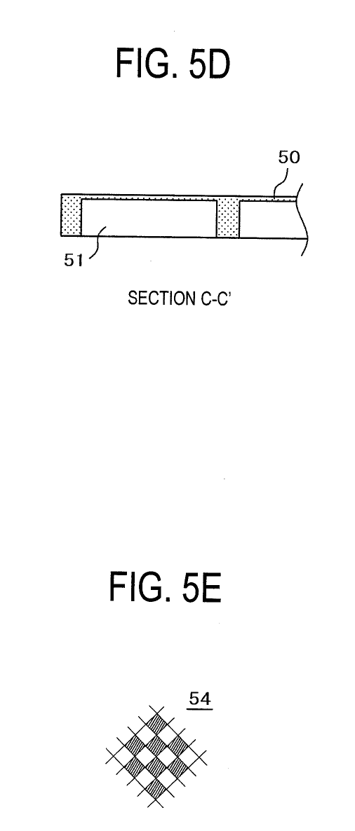

FIG. 5A to FIG. 5E illustrate the light guide plate of the invention. FIG. 5A is a top plan view of the light guide plate and FIG. 5B is a sectional view thereof taken on the line B-B′ in FIG. 5A. FIG. 5C is a fragmentary perspective view of the light guide plate and FIG. 5D is a sectional view thereof taken on the line C-C′ in the above fragmentary perspective view. FIG. 5E is a diagram showing a pattern.

The light guide plate 50 is typically formed of a transparent acrylic resin. The light guide plate has a half length and a half width of the liquid crystal panel or is one fourth the size of the liquid crystal panel. In the case of a 42 inch liquid crystal panel, for example, the light guide plate roughly measures 50 cm in width by 33 cm in length. The light guide plate 50 is a flat plate having a constant thickness on the order of 2 to 4 mm.

The light guide plate is formed with the cavities 51 of the inverted U-shape to receive the LEDs 32 mounted on the LED substrate 30. The cavities are interconnected at upper sides thereof. The inverted-U shaped cavities 51 interconnected at the upper sides have a transversely elongated rectangular configuration. The elongated cavities 51 are arranged in transverse arrays at a space interval of about one third of the short side of the light guide plate 50. Slightly less than twenty elongated cavities are arranged on the light guide plate along the width of about 50 cm.

Patterning is provided on a front or back surface of the light guide plate such that light guided to such a surface may be uniformly distributed thereacross. There are examples of modification of a checkerboard pattern suggested by the prior art. An exemplary modification of the pattern is shown in FIG. 5E. The light guide plate is patterned by injection molding using dies, sand blasting technique or the like.

Next, description is made on the reflection sheet 40 of the invention.

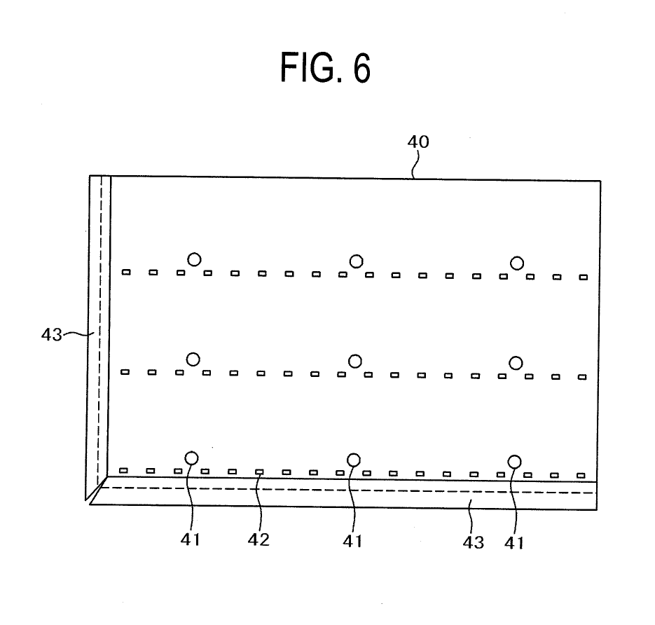

FIG. 6 shows the reflection sheet 40. The reflection sheet 40 is vertically divided into three equal parts, each of which is formed with cavities 42 at a lower side thereof. The cavity 42 has a rectangular shape such as to allow the LED 32 mounted on the LED substrate to be inserted therethrough.

The reflection sheet is formed with twenty or so rectangular cavities 42 at regular space intervals along the width of about 50 cm so as to allow the individual LEDs to be inserted therethrough. The cavities 42 are in corresponding relation with the LEDs of the LED substrate.

The reflection sheet 40 is further formed with three through-holes 41 per cavity row because the reflection sheet is secured to the chassis 10 by the light guide plate fixed thereto with screws.

The reflection sheet 40 is extended at portions abutting on the sides of the chassis 10 so as to cover the periphery of the chassis 10 when accommodated in the chassis 10. The extended portions define flanges 43 as additional reflection sheets. According to the embodiment, the flanges 43 as the additional reflection sheets and the reflection sheet 40 are integrally formed.

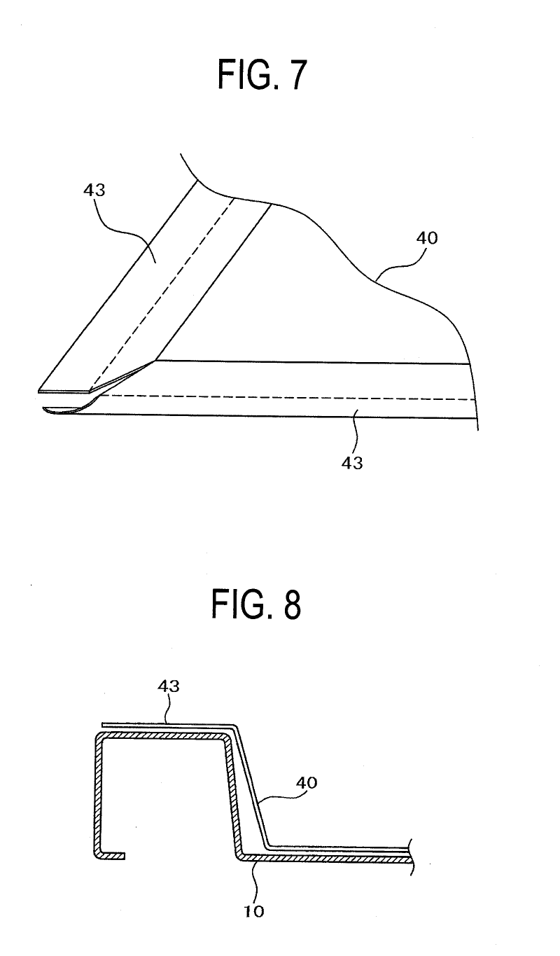

FIG. 7 is a fragmentary perspective view showing the reflection sheet 40. The reflection sheet 40 is made larger than the light guide plate 50 so as to define the flanges 43 and is incised at corners thereof. As shown in FIG. 8, the flanges of the reflection sheet 40 are configured to cover the periphery of the chassis 10. FIG. 8 is intended to illustrate a relation between the reflection sheet and the chassis and hence, the depiction of the insulation sheet and the LED substrate is omitted.

The following advantage is obtained by forming the flanges 43 around the reflection sheet 40 in this manner. Even in a case where the whole size of the light guide plate 50 is smaller than the effective display region of the liquid crystal panel and a wide gap is defined between the side edges of the light guide plate 50 and the entire periphery of the chassis, incident light on the gap can be efficiently guided toward the liquid crystal panel. Even though the whole size of the light guide plate 50 is smaller than the effective display region of the liquid crystal panel, the liquid crystal panel is prevented from being decreased in the lightness near the edges thereof, achieving an increased use efficiency of LED light. Furthermore, the flanges 43 are automatically interposed between the side edges of the light guide plate 50 and the entire periphery of the chassis by mounting the reflection sheet 40 because the flanges 43 and the reflection sheet 40 are integrally formed. This results in the increase in work efficiency (assemblability).

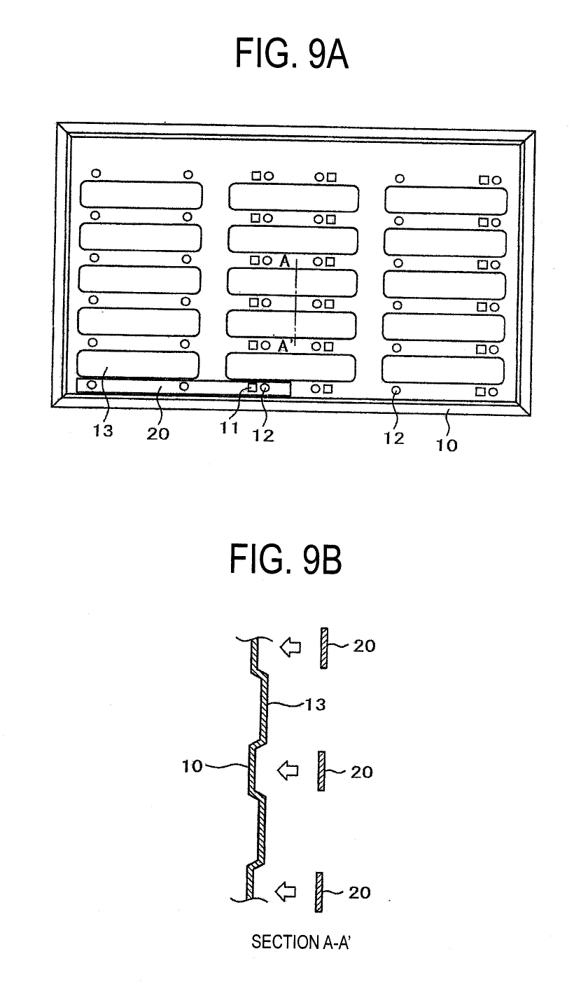

FIG. 9A and FIG. 9B show the chassis 10. FIG. 9A is a top plan view of the chassis 10 and FIG. 9B is a fragmentary sectional view thereof. The chassis 10 roughly measures 100 cm in width by 66 cm in length in the case of the 42 inch liquid crystal panel, for example. The chassis 10 is typically manufactured by press forming sheet iron. The chassis roughly measuring 100 cm in width by 66 cm in length tends to suffer post-forming warpage. Therefore, the chassis is formed of a sheet iron having a relatively great thickness on the order of 1 mm. Otherwise, as shown in FIG. 1, the chassis is stabilized by attaching a reinforcing material 110 to a back side thereof.

A central flat plate of the chassis 10 is formed with ribs 13 for increasing the strength thereof. The rib 13 has a longitudinally elongated oval shape and is protruded inwardly (toward the backlight). FIG. 9A shows the ribs arranged lengthwise in three columns, but the rib arrangement is not limited to this. The chassis 10 is shaped like a box to accommodate the backlight unit and is formed with flanges on the periphery thereof.

As shown in FIG. 9B, the insulation sheets 20 are laid between the ribs of the chassis 10 which are protruded toward the backlight. The insulation sheets electrically isolate the chassis 10 from the LED substrate laid thereon and also serve to release heat generated by the LEDs.

FIG. 9A shows an example where the insulation sheet 20 is installed at the lower left portion of the figure. In this manner, the insulation sheet is installed along aside of the rib 13. Specifically, the insulation sheet is installed along sides of plural ribs.

The chassis 10 is equipped with an LED driver board on the backside thereof. The chassis is formed with the square opening 11 through which the LED driver board is connected to the LED substrate of the backlight unit.

The chassis 10 further includes screw holes 130 (FIG. 2) formed in a surface (backlight side) thereof for allowing the screws to fix the light guide plate thereto. Four screw holes in total are formed, two holes on each side.

Pins (not shown) are anchored to the surface of the chassis 10 so as to position the light guide plate 50. The pins are inserted through positioning holes 53 of the light guide plate 50 as shown in FIG. 5A and into the bosses formed on the chassis 10 thereby positioning the light guide plate. This positioning has a minor freedom with respect to the transverse (horizontal) direction but no freedom is allowed with respect to the up-down (vertical) direction. This is because the positioning between the light guide plate and the LEDs is rigorously defined.

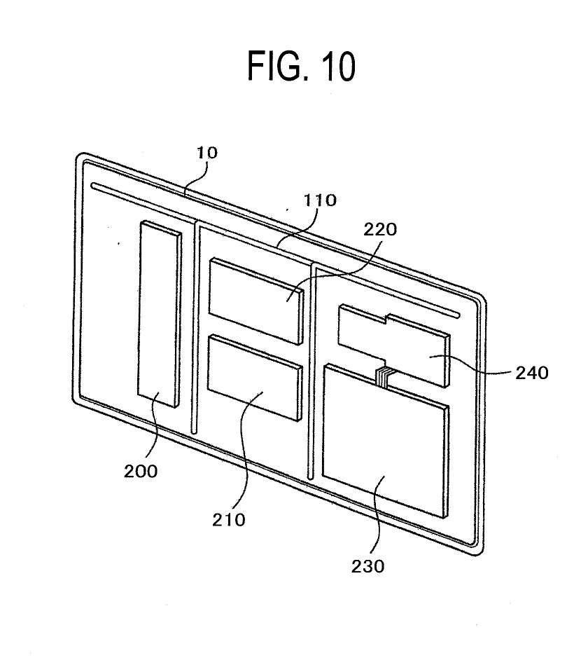

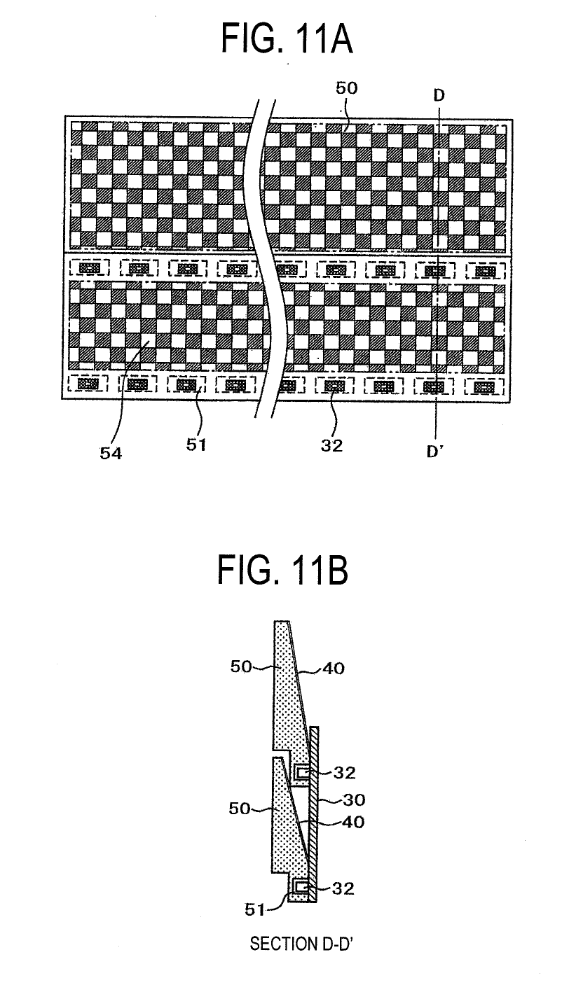

FIG. 10 shows the back side of the chassis 10.

The reinforcing material 110 is securely mounted on the back side of the chassis 10. Further, board mounting bosses are mounted on the back side of the chassis.

Circuit boards mounted on the back side of the chassis 10 include an LED driver board 200 for driving the LED substrate, a power supply board 220 for the whole liquid crystal display apparatus, a liquid crystal driver board 210 for driving the liquid crystal panel, a signal processing board 230 as a main board and an HDD unit 240. The HDD unit may be dismounted as needed.

The LED driver board 200 drives the LEDs 32 as connected to the LED substrate of the backlight unit via the square opening 11 of the chassis.

What is claimed is:

1. A liquid crystal display apparatus equipped with a backlight unit comprising:
an LED;
a light guide plate for light emission by guiding light from the LED to a liquid crystal panel;
an LED board for driving the LED;
a reflection sheet interposed between the light guide plate and the LED board; and
a chassis on which the LED, the light guide plate, the reflection sheet and the LED board are mounted,
the light guide plate having an emission surface opposed to the liquid crystal panel and divided into a plurality of sections, the backlight unit controlling the intensity of light through each of the sections according to an image,
wherein the reflection sheet has substantially the same size as the light guide plate divided into the sections and is extended at portions abutting on sides of the chassis.

2. The liquid crystal display apparatus according to claim 1, wherein the reflection sheet of the backlight unit is formed with a slit at corners.

3. A liquid crystal display apparatus equipped with a backlight unit comprising:
an LED;
a light guide plate for light emission by guiding light from the LED to a liquid crystal panel;
an LED board for driving the LED;
a reflection sheet interposed between the light guide plate and the LED board; and
a chassis on which the LED, the light guide plate, the reflection sheet and the LED board are mounted,
the light guide plate having an emission surface opposed to the liquid crystal panel and divided into a plurality of sections, the backlight unit controlling the intensity of light through each of the sections according to an image,
wherein an additional reflection sheet is provided between a periphery of the chassis and side edges of the light guide plate and the additional reflection sheet and the reflection sheet are integrally formed.
